(19) United States
(12) Patent Application Publication
(10) Pub. No.: US 2023/0159134 A1
(43) Pub. Date: May 25, 2023

(54) Shifting Device and Bicycle

(71) Applicant: VANMOOF B.V., Amsterdam (NL)

(72) Inventor: Ties Jonan Midas Carlier, Amsterdam (NL)

(21) Appl. No.: 17/920,239

(22) PCT Filed: Apr. 20, 2021
(86) PCT No.: PCT/NL2021/050253

§ 371 Date: Oct. 20, 2022

(30) Foreign Application Priority Data
Apr. 20, 2020 (NL) 2025379

(51) Int. Cl. B62M 9/123; B62J 45/41; B62M 6/40; B62M 6/90

(52) U.S. Cl. CPC B62M 9/123; B62J 45/41; B62M 6/40; B62M 6/90

(57) ABSTRACT

Provided is a shifting device for shifting of a bicycle gear, such as a hub gear, of a bicycle. The shifting device includes a main control unit and preferably a motor control unit. The device includes a shifting control unit for receiving shifting instructions from the main control unit or the motor control unit. The shifting control unit includes a processing unit and a memory, power receiving means, such as including an electrical connector, for receiving power from a battery of the main control unit and/or a drive motor battery of the bicycle, a shifting motor, such as an electric motor, such as a stepper motor for providing a shifting motion for driving a shifting assembly for actuating a gear actuator, the shifting assembly for transferring the shifting motion from the shifting motor to the gear actuator, and the gear actuator for transferring the shifting motion to the bicycle gear. The shifting control unit, by means of communication with and controlling by the main control unit of the bicycle, is configured as a subsystem of the bicycle. The shifting control unit shifts the bicycle gear at each time on the basis of shifting instructions from the main control unit or the motor control unit.

### CROSS REFERENCE TO RELATED APPLICATIONS

This application is the United States national phase of International Application No. PCT/NL2021/050253 filed Apr. 20, 2021, and claims priority to The Netherlands Patent Application No. 2025379 filed Apr. 20, 2020, the disclosures of which are hereby incorporated by reference in their entirety.

### BACKGROUND OF THE INVENTION

### Field of the Invention

The present invention relates to a shifting device for shifting of a bicycle gear, such as a hub gear, of a bicycle comprising a main control unit and preferably a motor control unit. Furthermore, the present invention relates to a bicycle with integrated drive coordination for performing of a central power coordination of motor power and humanpower from a main control unit.

### Description of Related Art

It is known that bicycles are equipped with a gear such that the pedaling force and pedaling speed is adaptable to the speed of the bicycle and conditions such as wind and slope of the road. In the state-of-the-art, such a gear is also carried out automatically on the basis of, for example, the speed of the bicycle by means of a device in an acceleration in which a flywheel was shifted based on the rotation of the flywheel. Also, electric actuators are used for shifting gears. A disadvantage of such a system is that those are added to a bicycle as a separate accessory that, for example, the user must switch by means of a button module.

### SUMMARY OF THE INVENTION

It is a goal of the present inventor to provide a combination of a bicycle with an electric auxiliary drive and a main control unit and automatic bicycle gears wherein the current state of a drive motor control and/or the current state of battle pedal is taken into account. To this end, the present invention provides a shifting device for shifting of a bicycle gear, such as a hub gear, of a bicycle comprising a main control unit and preferably a motor control unit, comprising:
a shifting control unit for receiving of shifting instructions from the main control unit or the motor control unit, comprising a processing unit and a memory,
power receiving means, such as comprising an electrical connector, for receiving of power from a battery of the main control unit and/or a drive motor battery of the bicycle,
a shifting motor, such as an electric motor, such as a stepper motor for providing a shifting motion for driving a shifting assembly for actuating of a gear actuator,
the shifting assembly for transferring of the shifting motion from the shifting motor to the gear actuator,
the gear actuator for transferring of the shifting motion to the bicycle gear, wherein:
   the shifting control unit, by means of communication with and controlling by the main control unit of the bicycle, is configured as a subsystem of the bicycle, and
   the shifting control unit shifts the bicycle gear at each time on the basis of shifting instructions from the main control unit or the motor control unit.

It is an advantage of such a shifting device according to the present invention that it functions as a subsystem of the bicycle in the control of the main control unit and/or the motor control unit by means of switching instructions. With this, it is advantageously realized that the shifting of the gears is performed based on information of the main control unit and/or the motor control unit.

With this, it is furthermore achieved that the switching instructions may be assembled based on information that is available to the main control unit and/or the motor control units. Such information relates to information with respect to pedaling force or pedaling speed, speed of the bicycle that may be determined for example on the basis of parameters of the drive motor. With this, it is furthermore provided that shortly before or during the shifting, the order power or drive power of the motor may be briefly slightly increased to achieve lowering of the load on the bicycle gear during shifting. With this, it is preferably provided that shifting is performed on the basis of decision rules comprising combination of such parameters. With the application of a drive motor in the hub of the front wheel and a bicycle gear in the hub in the rear wheel, it is advantageously achieved that forces of the motor do not provide a load to the bicycle gears, and even more importantly relieve the bicycle gears. In such a configuration, the motor power is not exerted to the gear hub, nor does it influence measurement of the pedaling force or pedaling speed of the user on the driveshaft.

According to a further preferred embodiment, the shifting device comprises at least one sensor for determining of the current gear of the bicycle gear and/or a current position of the gear actuator, preferably functioning together with at least one position indicator for the bicycle gear and/or the gear actuator. With this, the shifting device is capable of maintaining information regarding the current position of the gear actuator and of the bicycle gear in order to maintain a correctly shifted and/or correctly shifting between gears.

To this end, in the shifting device, the at least one sensor comprises at least one hall sensor, preferably functioning in cooperation with the at least one position indicator, such as a magnet element inducing a magnetic field for actuating of the at least one hall sensor. With this, a position of the bicycle gear and/or in the gear actuator may be determined in an advantageous manner. Preferably, the orientation of any of the at least one position indicator relative to any of the at least one sensor is determined such that activation of the sensor by the position indicator indicates the correct shifting of the bicycle gear. With this, it is furthermore provided that any control of the shifting motor beyond or towards an actuation of the sensor by the position indicator is usable for a calibration or ongoing calibration of the shifting of the bicycle gear.

Further preferably, one of the at least one position indicator functions as a zero point indicator or starting point indicator, preferably formed as a double or deviating magnetic element. With this, it may be realized that in case of fully shifting off of a power supply of the shifting device or the main control unit of the bicycle, a recalibration may be achieved by adding the switching control unit actuating the shifting motor until the zero point indicator or starting point indicator is present at a respective sensor. Further preferably, this position is therewith stored as starting point for a next calibration.

Further preferred shifting device wherein the at least one sensor is arranged adjacent to an edge of the bicycle gear or the gear actuator, preferably at a to this end suitably shaped circuit board, and wherein the at least one position indicator is arranged in or at the bicycle gear or the gear actuator.

Further preferred switching device wherein the shifting assembly comprises a transmission for transferring of the shifting motion from the shifting motor to the gear actuator.

Further preferred switching device wherein the shifting motor comprises a rotation axis with a driving means, such as a worm or threaded bar.

Further preferred switching device comprising a housing, preferably comprising an opening for allowing the transmission actuator to the bicycle gear.

Further preferred switching device arranged for arrangement between the hub and the rear stay, preferably also arranged for arrangement within an inner contour of the chain casing of the bicycle.

Further preferred switching device wherein the shifting control unit is arranged for sending of switching instructions to the main control unit or motor control unit.

A further aspect according to the present invention relates to a bicycle with integrated drive coordination to perform a central power coordination of motor power and humanpower from a main control unit, the bicycle comprising:
a frame with a front wheel and a rear wheel attached to it that is drivable by means of the humanpower from a crank set,
a drive battery for providing of energy for the purpose of motor power,
a drive motor, for providing of the motor power,
a gear assembly for shifting gears of the human force drive, and
the main control unit for providing of the integrated drive coordination by means of performing the central power coordination of motor power and humanpower, the main control unit comprising:
motor control means for controlling of the drive motor,
motor monitoring means for monitoring of at least a status of the drive motor, and
means for assembling of switching instructions on the basis of the at least one status of the drive motor, such as comprising a rotational speed.

By means of such aspect, a bicycle is provided in which by means of the main control unit shifting instructions are assembled for the purpose of a shifting device that shifts the bicycle gear as a subsystem of the bicycle. With this, it is furthermore advantageously realizable that the present or the usable motor power and humanpower is mutually adjustable in a desirable manner, such as in relation to the speed, by means of the shifting instructions.

According to a preferred embodiment, such a bicycle according to this aspect comprises a shifting device according to the above described aspect.

According to a further preferred embodiment, the main control unit comprises driveshaft monitoring means for monitoring of pedaling force and/or pedaling movement for providing of further input for the purpose of assembling of the switching instructions.

Further preferred bicycle wherein the drive motor is a hub motor that is preferably arranged in the front wheel.

An advantage thereof is that the drive forces are directly from the motor supplied to the rim of the respective wheel. With this, burdening of for example a drive chain of the bicycle is avoided. In case of arrangement of the motor in the front wheel, it is advantageously realized that gears for the purpose of humanpower are arrangeable in the rear wheel hub distinctly therefrom. This also avoids burdening of the rear wheel hub by the motor. Arrangement of gears for the purpose of humanpower in the rear wheel hub is relatively straightforward and reliably realizable in combination with this.

Further preferred bicycle wherein the gear assembly is a hub gear assembly that is arranged in the hub of the rear wheel of the bicycle.

Further preferred bicycle wherein the main control unit comprises a battery management system.

Further preferred bicycle comprising controlling of shifting of the gear assembly on the basis of a threshold value of the charge level of the drive battery to a predetermined gear, preferably followed by switching off of the main control unit. Further preferred bicycle comprising receiving means for receiving of instructions or parameters of decision rules from an external computing device, such as a smartphone, on the basis of which a user may set shifting moments such as for the purpose of shifting at a relatively low or a relatively high speed, or shifting at a relatively low or relatively high pedaling speed or shifting at a relatively low or relatively high pedaling force.

Further advantages, features and details of the present invention will be further elucidated on the basis of a description of one or more preferred embodiments with reference to the accompanying figures. Similar yet not necessarily identical parts of different preferred embodiments may be indicated with the same reference numerals.

### BRIEF DESCRIPTION OF THE DRAWINGS

FIG. 1 relates to a schematic representation in side view of a first preferred embodiment according to the present invention.

FIG. 2 relates to a schematic representation such as comprising steps of a method of a further preferred embodiment according to the present invention.

FIG. 3 relates to a schematic representation of a system overview according to a further preferred embodiments.

FIG. 4 relates to a schematic representation of a system overview according to a further preferred embodiments.

FIG. 5 relates to a schematic representation of a preferred embodiment relating to shifting points per speed.

FIG. 6 relates to a perspective view of a preferred embodiment according to FIG. 1 in top view while mounted at a bicycle.

### DESCRIPTION OF THE INVENTION

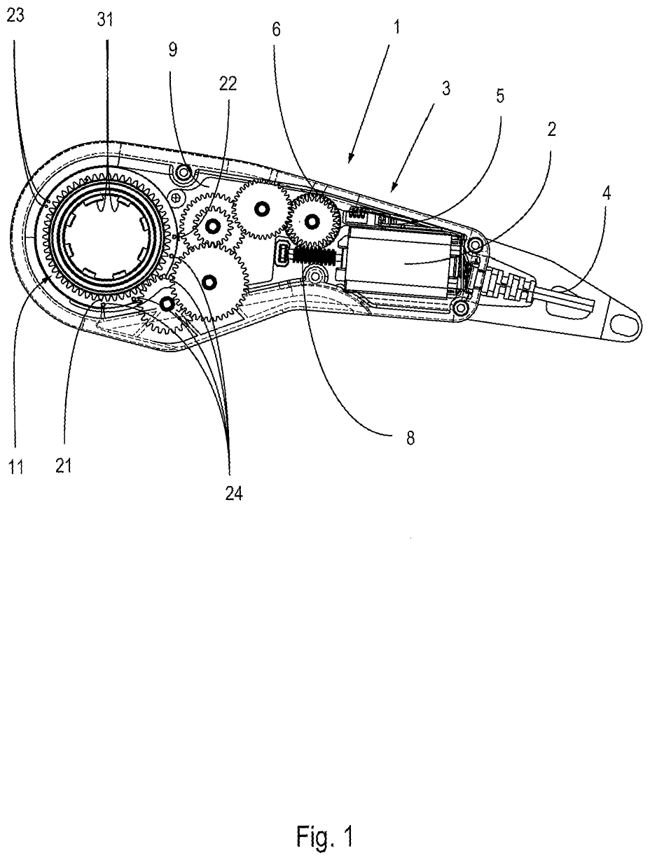

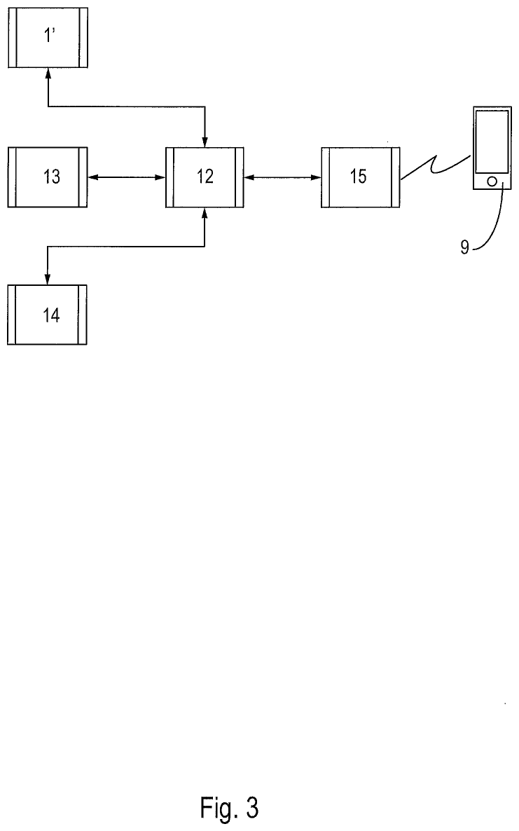

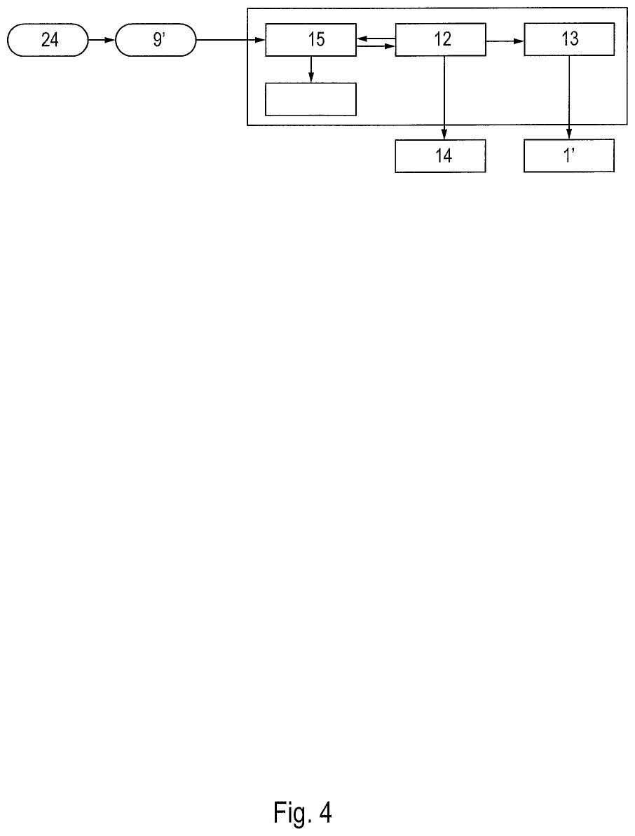

A first preferred embodiment (FIG. 1) according to the present invention relates to a shifting device 1. It comprises a connection 4 by means of a wire with a main control unit 12, such as for example shown in FIG. 3 or 4, of the bicycle. From the main control unit of the bicycle, the shifting device 1 is controlled for preferably each shifting in the bicycle gear. The shifting control unit of the shifting device that is embodied in the circuit board 9, to this end, controls the motor to for each shifting of the bicycle gear by means of power that is also obtained via the connection 4. The motor drives the worm 8 because of which the gear assembly 10 is set into motion by means of the shifting motion of the drive motor. With this, gear actuator 11 is ultimately driven towards the next gear. The gear actuator has transmission cams 31 for transmitting of the motion to the bicycle gear by means of thereto suitable corresponding cams of the bicycle gear.

The gear actuator 11 has a number of magnets 24 for actuating of a respective hall sensor 21, 22 that are arranged at the circuit board 9. With this, the shifting control unit is provided with information relating to the position of the gear actuator. A double magnet 23 provides a zero setting to the respective hall sensor. In case, for example because of a power interruption, the control unit is no longer informed as to the position of the gear actuator 11, it will move the gear actuator to a point in which the double magnet 23 reaches the respective hall sensor for the purpose of renewedly calibrating of the shifting device such that with this, it is known in which gear setting the bicycle gear currently is.

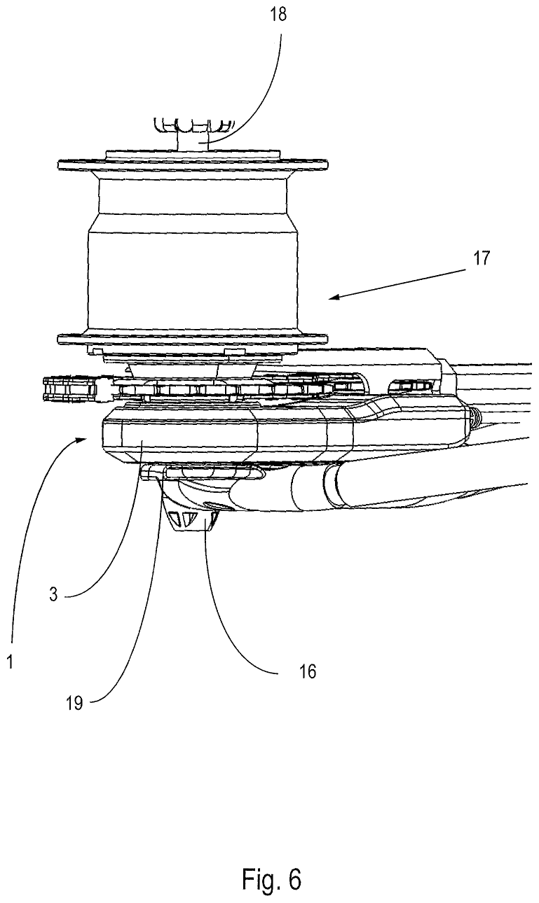

In FIG. 6, it is shown how the shifting device 1 is arrangeable relative to the hub 17, the chain casing and the rear stay.

The controlling of the shifting device 1′ is performed from the main control unit 12 of the bicycle as is shown as preference in FIG. 3. The main control unit 12 of the bicycle determines shifting moments depending from predetermined parameters. To this end, the control unit 13 of the drive motor for example provides information with respect to power of the motor and/or speed of the bicycle. A crank sensor provides information relating to the pedaling force and/or pedaling speed. With this, it may be determined by means of predetermined determining steps at which values of the parameters and shifting is to be performed.

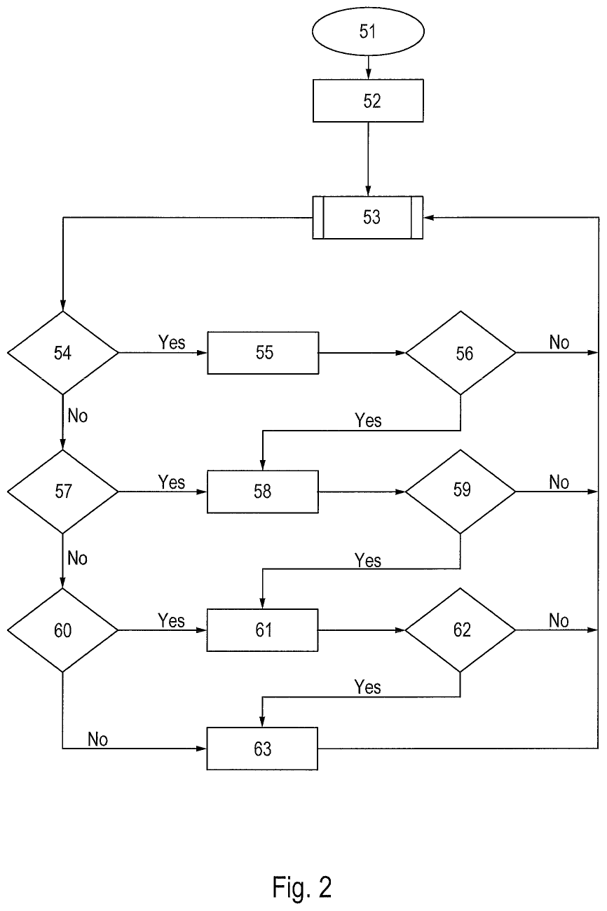

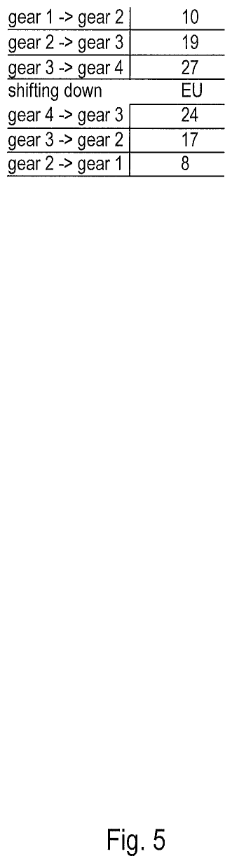

FIG. 2 shows a schematic representation in which a representation is shown that shifting is performed at predetermined speeds, such as according to FIG. 5 that has been used as an example, beginning in step 51. From the originating first gear 63 according to step 52, the shifting process starts in step 53. In case it is determined in step 60 that the speed is higher than a predetermined speed, such as 10 km/h, shifting is performed to the second gear 61. In case it is determined in step 57 that the speed is higher than the predetermined speed 19, shifting is performed to the third gear 58. In case in step 54, it is determined that the speed is higher than the predetermined speeds 27, shifting is performed to the fourth gear 55. In case in step 56 it is determined that the speed is lower than the predetermined speeds 24, the gear is shifted to the third gear 58. In case in step 59, it is determined that the speed is lower than the predetermined speeds 17, shifting is performed to the second gear 61. In case in step 62 it is determined that the speed is lower than the predetermined speed 8, shifting is performed to the first gear 63.

In FIG. 5, an example is shown of shifting speeds of predetermined speeds in case the speed is leading. The user of the bicycle can, as is shown in FIG. 4, from the smartphone 9′ via an application, transfer parameters as indicated in the above to the main control unit 12 of the bicycle.

A further preferred embodiment according to the present invention relates to an actuation unit for a gear hub that is arrangeable at the location of an actuation input of the gear hub, the actuation unit comprising a housing, and in the housing arranged actuation motor for providing of drive energy to the actuation unit, a transfer unit for transferring of an actuation motion to the actuation input of the gear hub, and transfer means for transferring of the drive energy of the moderate to the transfer unit. Furthermore, the actuation unit preferably comprises positioning determining means or orientation determining means for determining of a position or orientation of the actuation input of the gear hub.

The present invention is described in the foregoing on the basis of preferred embodiments. Different aspects of different embodiments are expressly considered disclosed in combination with each other and in all combinations that on the basis of this document, when read by a skilled person of the area of skill, fall within the scope of the invention or are deemed to be read with the disclosure of this document. These preferred embodiments are not limitative for the scope of protection of this document. The rights sought are defined in the appended claims.

1. A shifting device for shifting of a bicycle gear, such as a hub gear, of a bicycle comprising a main control unit and preferably a motor control unit, comprising:
a shifting control unit for receiving of shifting instructions from the main control unit or the motor control unit, comprising a processing unit and a memory.
power receiving means, such as comprising an electrical connector, for receiving of power from a battery of the main control unit and/or a drive motor battery of the bicycle.
a shifting motor, such as an electric motor, such as a stepper motor for providing a shifting motion for driving a shifting assembly for actuating of a gear actuator.
the shifting assembly for transferring of the shifting motion from the shifting motor to the gear actuator, and
the gear actuator for transferring of the shifting motion to the bicycle gear, wherein:
the shifting control unit, by means of communication with and controlling by the main control unit of the bicycle, is configured as a subsystem of the bicycle,
the shifting control unit shifts the bicycle gear at each lime on the basis of shifting instructions from the main control unit or the motor control unit.

2. The shifting device according to claim 1 comprising at least one sensor for determining of the current gear of the bicycle gear and/or a current position of the gear actuator, preferably functioning together with at least one position indicator for the bicycle gear and/or the gear actuator.

3. The shifting device according to claim 2, wherein the at least one sensor comprises at least one hall sensor, preferably functioning in cooperation with the at least one position indicator, such as a magnet element inducing a magnetic field for actuating of the at least one hall sensor.

4. The shifting device according to claim 2, wherein one of the at least one position indicator functions as a zero point indicator or starting point indicator, preferably performed as a double or deviating magnetic element.

5. The shifting device according to claim 2, wherein the at least one sensor is arranged adjacent to an edge of the bicycle gear or the gear actuator, preferably at a to this end suitably shaped circuit board, and wherein the at least one position indicator is arranged in or at the bicycle gear or the gear actuator.

6. The shifting device according to claim 1, wherein the shifting assembly comprises a transmission for transferring of the shifting motion from the shifting motor to the gear actuator.

7. The shifting device according to claim 1, wherein the shifting motor comprises a rotation axis with a driving means, such as a worm or threaded bar.

8. The shifting device according to claim 1, comprising a housing, preferably comprising an opening for allowing the transmission actuator to the bicycle gear.

9. The shifting device according to claim 1, arranged for arrangement between the hub and the rear stay, preferably also arranged for arrangement within an inner contour of the chain casing of the bicycle.

10. The shifting device according to claim 1, wherein the shifting control unit is arranged for sending of switching instructions to the main control unit or motor control unit.

11. A bicycle with integrated drive coordination to perform a central power coordination of motor power and humanpower from a main control unit, the bicycle comprising:
a frame with a front wheel and a rear wheel attached to it that is drivable by means of the humanpower from a crank said,
a drive battery for providing of energy for the purpose of motor power,
a drive motor, for providing of the motor power,
a gear assembly for shifting gears of the human force drive, and
the main control unit for providing of the integrated drive coordination by means of performing the central power coordination of motor power and humanpower. the main control unit comprising:
motor control means for controlling of the drive motor,
motor monitoring means for monitoring of at least a status of the drive motor, and
means for assembling of switching instructions on the basis of the at least one status of the drive motor, such as comprising a rotational speed.

12. according to claim 11, comprising a shifting device comprising:
a shifting control unit for receiving of shifting instructions from the main control unit, comprising a processing unit and a memory,
a power receiving means, such as comprising an electrical connector, for receiving of power from a battery of the main control unit and/or, a drive motor battery of the bicycle,
a shifting motor, such as an electric motor, such as a stepper motor for providing a shifting motion for driving a shifting assembly for actuating of a gear actuator,
the shifting assembly for transferring of the shifting motion from the shifting motor to the gear actuator, and
the gear actuator for transferring of the shifting motion to the bicycle gear, wherein:
the shifting control unit, by means of communication with and controlling by the main control unit of the bicycle, is configured as a subsystem of the bicycle,
the shifting control unit shifts the bicycle- gear at each time on the basis of shifting instructions from the main control unit, and
the bicycle gear comprises a hub gear.

13. The bicycle according to claim 11, wherein the main control unit comprises driveshaft monitoring means for monitoring of pedaling force and/or pedaling movement for providing of further input for the purpose of assembling of the switching instructions.

14. The bicycle according to claim 11, wherein the drive motor is a hub motor that is preferably arranged in the front wheel

15. The bicycle according to claim 11, wherein the gear assembly is a hub gear assembly that is arranged in the hub of the rear wheel of the bicycle.

16. The bicycle according to claim 11, wherein the main control unit comprises a battery management system.

17. The bicycle according to claim 11, comprising controlling of shifting of the gear assembly on the basis of a threshold value of the charge level of the drive battery to a predetermined gear, preferably followed by switching off of the main control unit.

18. The bicycle according to claim 11, comprising receiving means for receiving of instructions or parameters of decision rules from an external computing device, such as a smartphone, on the basis of which a user may set shifting moments such as for the purpose of shifting at a relatively low a relatively high speed, or shifting at a relatively low or relatively high pedaling speed or shifting at a relatively low or relatively high pedaling force.
